(19) United States
(12) Patent Application Publication
(10) Pub. No.: US 2009/0149606 A1
(43) Pub. Date: Jun. 11, 2009

(54) DEGRADABLE PLASTIC COMPOSITION AND METHODS

(76) Inventor: HENRY O. MEISSNER, Elanora (AU)

Correspondence Address: ITALIA IP, 3500 WEST OLIVE AVE., SUITE 300, BURBANK, CA, 91505, US

(21) Appl. No.: 12/271,156

(22) Filed: Nov. 14, 2008

(30) Foreign Application Priority Data
Dec. 10, 2007 (AU) 2007906693

(51) Int. Cl. C08F 4/06; C08L 23/08

(52) U.S. Cl. 525/240; 525/360; 525/370

(57) ABSTRACT

A degradable plastic product is produced from a polymer blend composition which includes a thermoplastic polymer and a photo-oxidative degrading additive. The photo-oxidative degrading additive includes a photoactive degradant and an oxidation catalyzing additive.

### CROSS-REFERENCE TO RELATED APPLICATION

This application claims the benefit of the filing date under 35 USC 119(a) of IP Australia Provisional Patent Application No. 2007906693, filed Dec. 10, 2007, the contents of which are incorporated herein by reference.

### BACKGROUND OF INVENTION

The present invention relates to degradable plastics for use in the manufacture of degradable plastic products, to degradable plastic products formed therefrom, and to methods of forming degradable plastic products.

Plastic materials are widely used nowadays in items such as films, packaging, bottles and the like because plastics are durable and cheap to manufacture. However, the durability of plastics also has negative environmental impacts as the materials degrade very slowly. For example, the half life of the biological degradation of polyethylene has been extrapolated to be about 100 years. In some cases, burning plastic can release toxic fumes. Unfortunately, recycling plastics has proven difficult.

In an effort to overcome these shortcomings, there have been many efforts to develop degradable plastics. The term “degradable” means that the macromolecular structure of the plastic is able to be broken down into smaller molecular structures which are less likely to persist in the environment. The degradation process is usually triggered upon exposure of the degradable plastic to one or more specific environmental conditions. For example, degradable plastics can be degraded physico-chemically upon exposure to thermal (oxidative degrdadation) or ultraviolet (photodegradable) action. In addition, or alternatively, degradable plastics can be degraded biologically by the action of microorganisms (biodegradable).

A biodegradable plastic is a degradable plastic in which the degradation results from the action of naturally occurring microorganisms over a period of time (eg. up to 2-3 years in a landfill). Biodegradation of plastics can be achieved by enabling microorganisms in the environment to metabolise the molecular structure of plastics to produce an inert humus-like material that is less harmful to the environment. This reduces problems with litter and reduces harmful effects on wildlife.

A compostable plastic is a plastic that undergoes biological degradation during the composting process to yield carbon dioxide, water, inorganic compounds and biomass at a rate consistent with other known compostable materials and leaves no visually distinguishable or toxic residues.

A photodegradable plastic is a plastic that degrades as a result of exposure to UV radiation, usually from sunlight.

The period of time before which a degradable plastic begins to break down depends on the end use of the plastic. For example, the product life of a plastic bottle may be a number of years to take account of the time the plastic needs to remain sound and intact during filling, wholesale storage, retail storage, home storage and eventual use and disposal. On the other hand, a mulch film may only be required to remain intact for several months before it is desirable for it to start breaking down.

There is a need for methods and compositions that can be used to control the timing of the onset of degradation of a degradable plastic.

### SUMMARY

The present invention has arisen from the discovery that photo-oxidative additives can be blended with thermoplastic polymers in different proportions to produce a range of degradable plastics which undergo thermal-oxidative and/or photo-oxidative degradation and are compostable under commercial conditions. The type and/or amounts of photo-oxidative additives can be adjusted to “tune” the timing of the onset of degradation of a plastic product formed from a thermoplastic polymer that has been blended with the additives.

The present invention provides a polymer blend composition for use in the manufacture of a degradable plastic product, the polymer blend composition including a photo-oxidative degrading additive and a thermoplastic polymer, the photo-oxidative degrading additive including a photoactive degradant and an oxidation catalyzing additive.

In an embodiment, an amount of about 1% to about 5% (inclusive) by weight of the photo-oxidative degrading additive is blended with the thermoplastic polymer.

The photo-oxidative degrading additive triggers degradation of the thermoplastic polymer structure to form particles of degraded plastic which are then able to be subjected to decomposition by microbial activity in a composting process.

The photo-oxidative degrading additive is particularly suitable for blending with polyolefin-based thermoplastic polymers, such as polyethylene, polypropylene or polystyrene, and blends thereof and copolymers thereof.

The photoactive degradant may be selected from the group consisting of: an unsaturated fatty acid composition containing a metal ion, such as Co, Fe, Mg, Zn, Ce; metallic oxides, such as FeO, Fe₂O₃, ZnO, TiO; and inorganic salts, such as FeCl₃, CuCl₂, CoCl₂.

The oxidation catalyzing additive may be selected from the group consisting of: a copolymer of ethylene and carbon monoxide; and a vinyl ketone copolymer. The carbonyl group (CO) content may be from about 1% up to about 8% in the polymer. The degradation time of the copolymer of ethylene and carbon monoxide or the vinyl ketone copolymer can be controlled (increased or decreased) by controlling the carbonyl group content of the copolymer.

The present invention also provides a degradable plastic product formed from the polymer blend composition. The degradable plastic product may be an article, packaging, film, etc.

The present invention also provides a method of forming a degradable plastic product, the method including blending a photo-oxidative degrading additive including a photoactive degradant and an oxidation catalyzing additive with a thermoplastic polymer to form a polymer blend composition, and extruding the polymer blend composition to form the degradable plastic product. The invention also provides a degradable plastic product formed using the method.

The present invention also provides a method for producing a degradable plastic product that begins to degrade after a predetermined time period, the method including:
providing a photo-oxidative degrading additive including a photoactive degradant and an oxidation catalyzing additive;
providing a thermoplastic polymer;
determining an amount of photo-oxidative degrading additive to be blended with the thermoplastic polymer to provide for said predetermined time period in the degradable plastic product;
blending the photo-oxidative degrading additive with the thermoplastic polymer to form a polymer blend composition; and
extruding the polymer blend composition to form the degradable plastic product.

The invention also provides a degradable plastic product formed using the aforementioned method.

The present invention also provides a process for making a degradable plastic product from a polyolefin thermoplastic polymer, the process including:
introducing into an extruder said polyolefin resin;
introducing into the extruder a photo-oxidative degrading additive including a photoactive degradant and an oxidation catalyzing additive; and
forming a product.

The invention also provides a degradable plastic product formed using the aforementioned process.

### BRIEF DESCRIPTION OF THE DRAWINGS

The drawings, when considered in connection with the following description, are presented for the purpose of facilitating an understanding of the subject matter sought to be protected.

FIG. 1 is a graphical representation of oxidative degradation of a plastic film prepared from a composition of the invention as described in Example 2; and

FIG. 2 is a graphical representation of photo degradation of a plastic film prepared from a composition of the invention as described in Example 2.

### DETAILED DESCRIPTION

Before proceeding to describe the present invention, and embodiments thereof, in more detail it is important to note that various terms that will be used throughout the specification have meanings that will be well understood by a person having ordinary skill in the art. However, for ease of reference, some of these terms will now be defined.

The term “plastic”, and variants thereof, as used throughout the specification is to be understood to mean a synthetic or semisynthetic thermoplastic polymer excluding rubber. Thermoplastic polymers are capable of flowing under heat and pressure and they can be molded. Plastics are composed of condensation or addition polymers and may contain other substances to improve performance or economics. As a raw material, plastics are often in the form of pellets of thermoplastic polymer that are heated and extruded for the manufacture of packaging, films, articles and the like.

The term “blend”, and variants thereof, as used throughout the specification is to be understood to mean mixing two or more materials to obtain a new material or particular quality.

The term “degrade”, and variants thereof, as used throughout the specification in relation to plastics is to be understood to mean a material that breaks down, by microbial/fungal, thermal, oxidative, ultraviolet action or any combination of them. Degradation of a plastic results from the macromolecular structure of the plastic being broken down into smaller molecular structures.

The present invention provides a polymer blend composition for use in the manufacture of a degradable plastic product. The polymer blend composition includes a photo-oxidative degrading additive and a thermoplastic polymer. The photo-oxidative degrading additive includes a photoactive degradant and an oxidation catalyzing additive.

The photo-oxidative degrading additive is used in the formulation of polymer blend compositions for further manufacturing of specific degradable plastic products including, but not limited to: film, overwrap, shopping bags, waste and bin liner bags, composting bags, mulch film, silage wrap, landfill covers, packaging, oxygen or water barriers, bait bags, nappy backing sheet, cling wrap, personal care products, bottles, containers, planter boxes, food service cups, cutlery, trays, and straws, loose fill foam, and the like. The polymer blend compositions may be particularly useful for manufacturing degradable plastic products that may end up as compostable waste (e.g. garbage bags) or for products which come into contact with the soil and are intended to disintegrate after a desired time (e.g. agricultural films).

Advantageously, the photo-oxidative degrading additive allows for the formulation of degradable plastic products having a pre-determined time for triggering the degradation process. Specifically, inclusion of the additive composition in to polymer blend compositions for the manufacture of degradable plastic products allows for predetermined time and environmental condition dependent physico-chemical degradation of the plastic. The physico-chemical degradation is then followed by biological degradation of the degraded plastic during composting under aerobic conditions into CO₂ and H₂O as end products, or under anaerobic conditions into CH₄ and H₂O as end products.

Each of the processes in this two step process of physico-chemical degradation and biological degradation can be carried out separately or simultaneously. Typically, the physico-chemical degradation will be triggered first and the biological degradation process will follow.

The photoactive degradant and the oxidation catalyzing additive initiate and maintain the physico-chemical degradation. Specifically, the thermoplastic polymer degrades in the presence of a required dosage of UV radiation (sunlight) and heat (in the presence of oxygen) to a brittle degraded plastic material which is broken down into fragments (often by the mechanical actions in a municipal solid waste composting process). The molecular weight of the plastic fragments decreases quickly and continuously such that the low molecular weight plastic fragments can ultimately be biodegraded in the presence of microorganisms.

Under the action of ultraviolet radiation (typically provided by sunlight) or heat or under composting conditions, free radicals such as hydroxyl radicals are formed due to the presence of the photoactive additive and the auto-oxidation catalyzing additive, and these can react with the polymers, forming other free radicals. These free polymer radicals are extremely reactive and can, inter alia, react further with oxygen or with other polymer chains. The polymer chains are thus split and small chains are formed. During this process, the photoactive degradant acts both as an initiator and as a reaction promoter, whereas the oxidation catalyzing additive acts as a reaction promoter and especially as a chain splitter. This process repeats itself as long as the polymer is exposed to the ultraviolet radiation or heat. In this phase, the plastic materials become brittle and fragile and disintegrate into small particles of a few mm² up to few cm².

In the second stage, particles of the degraded plastic that are formed as a result of the physico-chemical degradation process are decomposed in the presence of bacteria, fungi and/or enzymes (i.e. microorganisms), such as occur under composting conditions or in contact with the soil. Due to the disintegration into small particles, the area of the polymer subject to attack by the microorganisms is enlarged several times. Depending on the prevailing conditions, the degradation processes of the first stage can still continue, leading to even shorter oxygen-containing polymer chains which, due to the close contact with the microorganisms, are in turn partially degraded further. In this way, complete biodegradation at the end of the second stage can be achieved. In general, this takes place, for example, under composting conditions that are typically used in municipal waste depots.

Plastic products made from the polymer blend composition which are placed in soil or sea water will biodegrade at variable rates. The biodegradation rate depends on conditions such as moisture level (soil), air (oxygen) concentration, temperature, presence of microorganisms, etc. The presence of ultraviolet radiation in the sunlight, light intensity and temperature will also influence the degradation rate.

The photo-oxidative degrading additive is blended in pre-determined proportions of between about 1% and about 5% (inclusive) with the thermoplastic polymer. Stability (i.e. the length of time before substantive physico-chemical degradation of the plastic begins) of the resultant degradable thermoplastic polymer is typically between 6 months to 2 years, depending on storage conditions (temperature, moisture, and light intensity and spectrum). Stability of each particular degradable thermoplastic polymer with a particular percentage level of photo-oxidative degrading additive can be determined in a laboratory using an accelerated oxidative degradation test (under constant conditions 70° C. and 50% relative humidity).

Degradation of the degradable thermoplastic polymer is triggered by exposure to full spectrum of sun light or UV light. A total quantity of UV energy input of 300 to 600 Watts ensures loss of physical properties (% elongation and tensile strength), which is caused by fragmentation of the thermoplastic polymer. Fragmentation is further accelerated by oxidation induced by the oxidation catalyzing additive which, under composting conditions, eventually results in the degradable thermoplastic polymer turning into small polymer and monomer fragments which are suitable for composting.

The relative proportions of the photo-oxidative degrading additive and the thermoplastic polymer will determine the length of time before degradation will start. Indeed, the adjustment of the relative proportions of the photo-oxidative degrading additive and the thermoplastic polymer can be used to “tune” the starting time for the degradation process. For example, with a 600 W UV power equivalent input achieved by exposure to an artificial UV generated source, degradation typically commences immediately with the product ready for composting from this point on. Alternatively, on exposure to sunlight (light source with full spectrum 270 nm to 3000 nm), once the accumulated energy input reaches a level of about 300 W to about 600 W, then, depending on the strength of the energy source, the degradation process may take up to 2 years before the physical structure will start to deteriorate and the functionality of plastic will be lost (as measured by elongation and tensile strength).

The thermoplastic polymer may be any regular thermoplastic polymer to which the photo-oxidative degrading additive is added during blending ready to extrude plastic products. The thermoplastic polymer may be a homopolymer, a copolymer or a terpolymer of an olefin monomer. For example, the polymer may be a polyolefin selected from the group consisting of: polyethylene, polypropylene, polystyrene, and blends thereof.

The polyethylene may be low density polyethylene (LDPE), linear low density polyethylene (LLDPE), very low density polyethylene (VLDPE), high density polyethylene (HDPE), linear medium density polyethylene (LMDPE), medium density polyethylene (MDPE), etc.

The polyolefin may also be any of the copolymers of ethylene, propylene and other monomers such as butene, pentene, hexene or octane. The polyolefin may also be a copolymer such as polyethylene acrylic acid (EAR), polyethylene vinyl acetate (EVA), polyethylene methacrylic acid (EMA), the ethylene-based ionomers, polybutylene and its related copolymers, copolymers of ethylenepropylene, copolymers of ethylene-carbon monoxide (ECO), and blends of these polymers.

The photoactive degradant is selected from the group consisting of: an unsaturated fatty acid composition containing a metal ion, such as Co, Fe, Mg, Zn, Ce; metallic oxides, such as FeO, Fe₂O₃, ZnO, TiO; and inorganic salts, such as FeCl₃, CuCl₂, CoCl₂.

The oxidation catalyzing additive is selected from the group consisting of: a copolymer of ethylene and carbon monoxide; and a vinyl ketone copolymer. The carbonyl group (CO) content may be from about 1% up to about 8% in the polymer. The degradation time of the copolymer of ethylene and carbon monoxide or the vinyl ketone copolymer can be controlled (increased or decreased) by controlling the carbonyl group content of the copolymer.

The photo-oxidative degrading additive includes a combination of the photoactive degradant and the oxidation catalyzing additive plus any other optional ingredients or excipients as required. Optional ingredients that can be used in the photo-oxidative degrading additive include heat stabilizers, biodegradable polymers, biodegradable organic additives, inorganic additives, antiblocking agents, antistatic agents, slip agents, pigments, plasticizers, colorants, and the like.

The photo-oxidative degrading additive may be in the form of a concentrate or pellets containing all of the additive components. Alternatively, separate concentrates or pellets of any one or more of the additive components and of another one or more of the additive components may be supplied and blended together as required.

The photo-oxidative degrading additive may be prepared using any suitable method known to those skilled in the art. For example, each of the photoactive degradant and the oxidation catalyzing additive may be introduced into an extruder with the processing additive. The composition may then be extruded into strands which are subsequently pelletized.

Advantageously, the components of the additive composition are classified as food-grade materials. The additive does not contain starch and the levels of heavy metal are below the level considered acceptable by the relevant EU regulations. Thus, the present invention makes it possible to manufacture degradable plastic products which do not pollute the environment and which can be degraded without additional energy consumption and without releasing harmful substances.

Any method of blending the photo-oxidative degrading additive with the thermoplastic polymer can be used, provided that an intimate dispersion of the components in the polymer blend composition is formed. Methods of polymer blending known in the art can be used. These methods include dry mixing in a mixer, on a mill, on a Banbury mixer, or solution blending, or hot melt blending.

Polyethylene and polypropylene plastics containing the photo-oxidative degrading additive can be used in blown film, injection molding, blow molding and other resin conversion processes. Polystyrene plastics containing the photo-oxidative degrading additive can be used in production of various types of polystyrene products.

The polymer blend composition can be used to manufacture degradable plastic products by fabrication techniques known in the art as useful for the corresponding synthetic polymers. In most cases, no special modifications of normal molding, extruding, etc. procedures is necessary. Indeed, in most cases the plastics behave essentially as known polymers from the same predominant monomers, and can be used in similar known applications where the corresponding regular polymers are commonly used.

Some possible advantages of plastics containing the photo-oxidative degrading additive include:

They are light yellowish or bluish in color.

They are photodegradable.

They are biodegradable.

The additive composition is in the form of round shape pellets/granules.

They are printable with water based inks.

There is no need to “rinse” the processing facility before or after a production run.

The additive does not significantly effect physical properties, such as the tensile strength or elongation percentage, of plastics films.

The plastics do not absorb moisture.

Examples of materials and methods for use with the compositions and methods of the present invention will now be provided. In providing these examples, it is to be understood that the specific nature of the following description is not to limit the generality of the above description.

### EXAMPLE 1

### LLDPE Film

A degradable film was formed by blending 5% (by weight) photo-oxidative degrading additive with LLDPE and extruding a film at a film thickness of 1.4 mm.

Mechanical properties of film were then tested in accordance with ASTM Standard Testing Methods and the results are shown in Table 1.

TABLE 1

| PROPERTY | UNITS - | TEST METHOD | VALUE |
|---|---|---|---|
| Melt index | gin/10 min | D 1238 | 10 |
| Density | gm/cm3 | D 792 | 1.14 |
| Percent Starch | vt. # | TGA | NA |
| Moisture Content | wt. # | WRP test | Volatiles <0.5 |

NOMINAL BLOWN FILM PROPERTIES

| | | | |
|---|---|---|---|
| Tensile Strength | psi | D 882 | 2900 |
| Elongation | % | D 822 | 800 |
| Dar Drop Impact | gm | D 1065 | 97 |
| Tear Resistance | gm | D 1922 | 109 |
| Thermal StabiIity | Centigrade | — | 340 |
| Embrittlement time | days | Thermal Aging | >50 |

The mechanical properties of the degradable plastic are comparable to those of the plastic that has not been made using the additive composition.

### EXAMPLE 2

### PE Film

A degradable film was formed by blending 3% (by weight) photo-oxidative degrading additive with PE and blow film extruding a film at a film thickness of 50 microns.

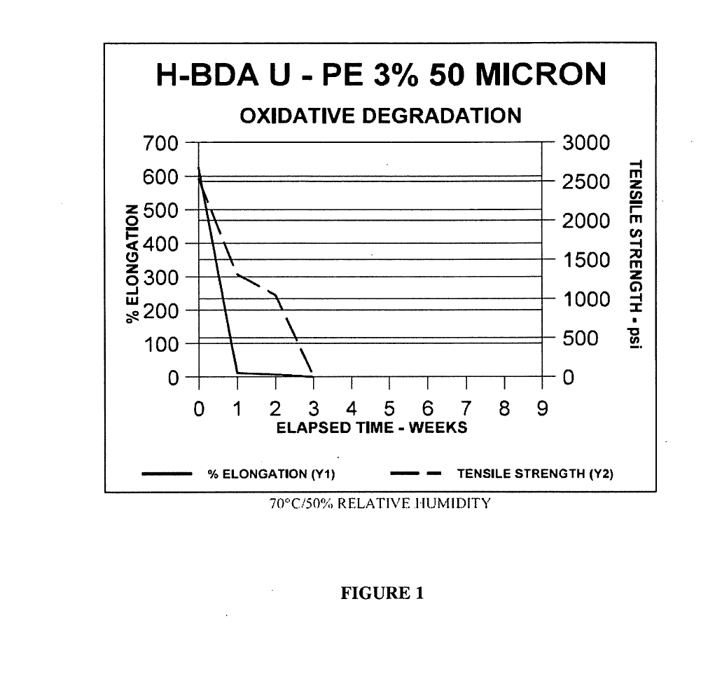

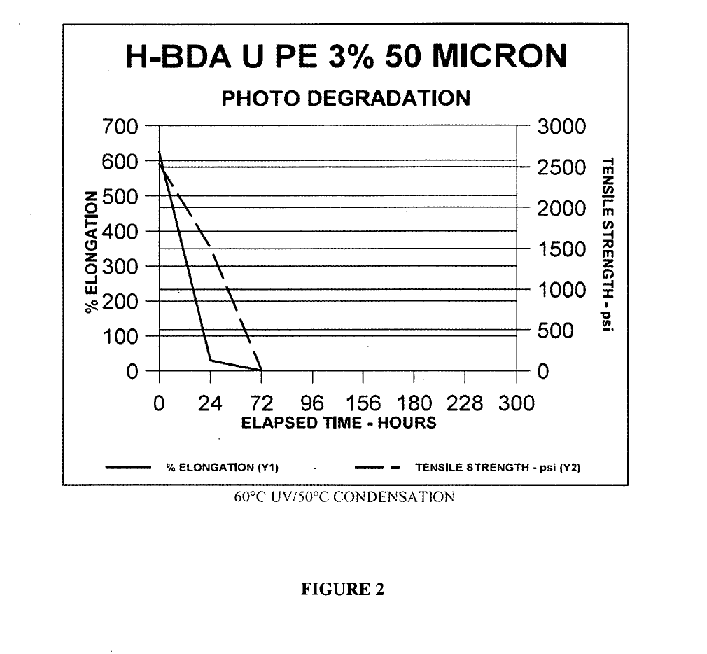

Mechanical properties of film were then tested in accordance with ASTM Standard Testing Methods and the results are shown in FIGS. 1 and 2.

### EXAMPLE 3

### PE and PP Product

A number of products were produced using polyethylene or polypropylene with the addition of the photo-oxidative degrading additive within the range 1% to 5%, including: plastic foil of different thickness for production of: (i) plastic bags (shopping, storage and garbage), (ii) packaging, agricultural, garden and industrial foil, (iii) foils without or with organic component, (iv) garden pots and (v) semi-transparent juice/liquid containers. All of the products were assessed in laboratory tests as degradable under thermal-oxidative and photo-oxidative conditions. Garden pots (as in iv above) were fully composted under large-scale composting conditions.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A polymer blend composition for use in the manufacture of a degradable plastic product, comprising:
a thermoplastic polymer; and
a photo-oxidative degrading additive, said photo-oxidative degrading additive including:
(a) a photoactive degradant, and
(b) an oxidation catalyzing additive.

2. The composition of claim 1, comprising from about 1% to about 5% by weight of said photo-oxidative degrading additive.

3. The composition of claim 1, wherein said photoactive degradant is selected from the group consisting of: an unsaturated fatty acid composition containing a metal selected from the group Co, Fe, Mg, Zn and Ce; a metallic oxide selected from the group FeO, Fe₂O₃, ZnO and TiO; and an inorganic salt selected from the group FeCl₃, CuCl₂ and CoCl₂.

4. The composition of claim 1, wherein said oxidation catalyzing additive is selected from the group consisting of a copolymer of ethylene and carbon monoxide and a vinyl ketone copolymer.

5. The composition of claim 1, wherein said thermoplastic polymer comprises a polyolefin.

6. The composition of claim 2, wherein said photoactive degradant is selected from the group consisting of: an unsaturated fatty acid composition containing a metal selected from the group Co, Fe, Mg, Zn and Ce; a metallic oxide selected from the group FeO, Fe₂O₃, ZnO and TiO; and an inorganic salt selected from the group FeCl₃, CuCl₂ and CoCl₂.

7. The composition of claim 6, wherein said oxidation catalyzing additive is selected from the group consisting of a copolymer of ethylene and carbon monoxide and a vinyl ketone copolymer.

8. The composition of claim 7, wherein said oxidation catalyzing additive comprises a carbonyl group (CO) content of from about 1% to about 8% by weight.

9. The composition of claim 8, wherein said thermoplastic polymer comprises a polyolefin.

10. The composition of claim 9, wherein said polyolefin comprises one or more polyolefins selected from the group consisting of polyethylene, polyethylene copolymer, polypropylene, polypropylene copolymer, polystyrene and polystyrene copolymer.

11. The composition of claim 7, wherein said thermoplastic polymer comprises a polyolefin.

12. The composition of claim 11, wherein said polyolefin comprises one or more polyolefins selected from the group consisting of polyethylene, polyethylene copolymer, polypropylene, polypropylene copolymer, polystyrene and polystyrene copolymer.

13. The composition of claim 6, wherein said thermoplastic polymer comprises a polyolefin.

14. The composition of claim 13, wherein said polyolefin comprises one or more polyolefins selected from the group consisting of polyethylene, polyethylene copolymer, polypropylene, polypropylene copolymer, polystyrene and polystyrene copolymer.

15. The composition of claim 2, wherein said oxidation catalyzing additive is selected from the group consisting of a copolymer of ethylene and carbon monoxide and a vinyl ketone copolymer.

16. The composition of claim 15, wherein said oxidation catalyzing additive comprises a carbonyl group (CO) content of from about 1% to about 8% by weight.

17. The composition of claim 16, wherein said thermoplastic polymer comprises a polyolefin.

18. The composition of claim 17, wherein said polyolefin comprises one or more polyolefins selected from the group consisting of polyethylene, polyethylene copolymer, polypropylene, polypropylene copolymer, polystyrene and polystyrene copolymer.

19. The composition of claim 15, wherein said thermoplastic polymer comprises a polyolefin.

20. The composition of claim 19, wherein said polyolefin comprises one or more polyolefins selected from the group consisting of polyethylene, polyethylene copolymer, polypropylene, polypropylene copolymer, polystyrene and polystyrene copolymer.

21. The composition of claim 2, wherein said thermoplastic polymer comprises a polyolefin.

22. The composition of claim 21, wherein said polyolefin comprises one or more polyolefins selected from the group consisting of polyethylene, polyethylene copolymer, polypropylene, polypropylene copolymer, polystyrene and polystyrene copolymer.

23. The composition of claim 3, wherein said oxidation catalyzing additive is selected from the group consisting of a copolymer of ethylene and carbon monoxide and a vinyl ketone copolymer.

24. The composition of claim 23, wherein said oxidation catalyzing additive comprises a carbonyl group (CO) content of from about 1% to about 8% by weight.

25. The composition of claim 24, wherein said thermoplastic polymer comprises a polyolefin.

26. The composition of claim 25, wherein said polyolefin comprises one or more polyolefins selected from the group consisting of polyethylene, polyethylene copolymer, polypropylene, polypropylene copolymer, polystyrene and polystyrene copolymer.

27. The composition of claim 23, wherein said thermoplastic polymer comprises a polyolefin.

28. The composition of claim 27, wherein said polyolefin comprises one or more polyolefins selected from the group consisting of polyethylene, polyethylene copolymer, polypropylene, polypropylene copolymer, polystyrene and polystyrene copolymer.

29. The composition of claim 3, wherein said thermoplastic polymer comprises a polyolefin.

30. The composition of claim 29, wherein said polyolefin comprises one or more polyolefins selected from the group consisting of polyethylene, polyethylene copolymer, polypropylene, polypropylene copolymer, polystyrene and polystyrene copolymer.

31. The composition of claim 4, wherein said oxidation catalyzing additive comprises a carbonyl group (CO) content of from about 1% to about 8% by weight.

32. The composition of claim 31, wherein said thermoplastic polymer comprises a polyolefin.

33. The composition of claim 32, wherein said polyolefin comprises one or more polyolefins selected from the group consisting of polyethylene, polyethylene copolymer, polypropylene, polypropylene copolymer, polystyrene and polystyrene copolymer.

34. The composition of claim 4, wherein said thermoplastic polymer comprises a polyolefin.

35. The composition of claim 34, wherein said polyolefin comprises one or more polyolefins selected from the group consisting of polyethylene, polyethylene copolymer, polypropylene, polypropylene copolymer, polystyrene and polystyrene copolymer.

36. The composition of claim 5, wherein said polyolefin comprises one or more polyolefins selected from the group consisting of polyethylene, polyethylene copolymer, polypropylene, polypropylene copolymer, polystyrene and polystyrene copolymer.

37. The composition of claim 1, formed into a degradable plastic product.

38. The composition of claim 2, formed into a degradable plastic product.

39. The composition of claim 3, formed into a degradable plastic product.

40. The composition of claim 4, formed into a degradable plastic product.

41. The composition of claim 5, formed into a degradable plastic product.

42. The composition of claim 6, formed into a degradable plastic product.

43. The composition of claim 7, formed into a degradable plastic product.

44. The composition of claim 8, formed into a degradable plastic product.

45. The composition of claim 9, formed into a degradable plastic product.

46. The composition of claim 10, formed into a degradable plastic product.

47. The composition of claim 11, formed into a degradable plastic product.

48. The composition of claim 12, formed into a degradable plastic product.

49. The composition of claim 13, formed into a degradable plastic product.

50. The composition of claim 14, formed into a degradable plastic product.

51. The composition of claim 15, formed into a degradable plastic product.

52. The composition of claim 16, formed into a degradable plastic product.

53. The composition of claim 17, formed into a degradable plastic product.

54. The composition of claim 18, formed into a degradable plastic product.

55. The composition of claim 19, formed into a degradable plastic product.

56. The composition of claim 20, formed into a degradable plastic product.

57. The composition of claim 21, formed into a degradable plastic product.

58. The composition of claim 22, formed into a degradable plastic product.

59. The composition of claim 23, formed into a degradable plastic product.

60. The composition of claim 24, formed into a degradable plastic product.

61. The composition of claim 25, formed into a degradable plastic product.

62. The composition of claim 26, formed into a degradable plastic product.

63. The composition of claim 27, formed into a degradable plastic product.

64. The composition of claim 28, formed into a degradable plastic product.

65. The composition of claim 29, formed into a degradable plastic product.

66. The composition of claim 30, formed into a degradable plastic product.

67. The composition of claim 31, formed into a degradable plastic product.

68. The composition of claim 32, formed into a degradable plastic product.

69. The composition of claim 33, formed into a degradable plastic product.

70. The composition of claim 34, formed into a degradable plastic product.

71. The composition of claim 35, formed into a degradable plastic product.

72. The composition of claim 36, formed into a degradable plastic product.
